(19) United States
(12) Patent Application Publication
(10) Pub. No.: US 2026/0048590 A1
(43) Pub. Date: Feb. 19, 2026

(54) IMAGE FORMING APPARATUS

(71) Applicant: KYOCERA Document Solutions Inc., Osaka (JP)

(72) Inventors: Yuki Nakaiwa, Osaka (JP); Hideya Muramoto, Osaka (JP); Hirotoshi Tagawa, Osaka (JP)

(21) Appl. No.: 18/807,304

(22) Filed: Aug. 16, 2024

(51) Int. Cl. B41J 2/21

(52) U.S. Cl. CPC B41J 2/2142; B41J 2/2135; B41J 2/2139; B41J 2/2146

(57) ABSTRACT

A recording head includes plural nozzle units. A nozzle unit position detecting unit detects positions of the nozzle units on the basis of a scanned image of a test pattern. The test pattern includes patch images corresponding to the plural nozzle units. Each of the patch image includes a first edge along a secondary scanning direction, and a second edge that crosses the first edge. On the basis of a density distribution of the test pattern, the nozzle unit position detecting unit determines an intersection point between the first edge and the second edge in each of the patch images, and determines respective positions of the plural nozzle units on the basis of positions of the determined intersection points.

### BACKGROUND

### 1. FIELD OF THE PRESENT DISCLOSURE

The present disclosure relates to an image forming apparatus.

### 2. DESCRIPTION OF THE RELATED ART

An inkjet image forming apparatus includes a recording head to which plural head units (nozzle units arranged plural nozzles) are attached; and in such an image forming apparatus, a test image such as line pattern or block pattern is printed, the printed test image is scanned, deviation of a hitting position of an ejected ink droplet is detected on the basis of the scanned test image, and deviation of a relative position of a nozzle unit to another nozzle unit is detected.

However, since density defect occurs in a line pattern or a block pattern as the test image when ink ejection malfunction occurs on a nozzle in the head unit, a position of the nozzle unit is not correctly detected.

### SUMMARY

An image forming apparatus according to an aspect of the present disclosure includes a recording head, a control unit, and a nozzle unit position detecting unit. The recording head includes plural nozzle units in which nozzles are arranged, and is configured to eject ink using the nozzles units. The control unit is configured to determine nozzles corresponding to an image to be printed and eject ink using the nozzle units. The nozzle unit position detecting unit is configured to (a) print a test pattern on a print sheet using the recording head and (b) detect positions of the nozzle units on the basis of a scanned image of the test pattern. Further, the test pattern includes patch images respectively corresponding to the plural nozzle units. Each of the patch image includes a first edge along a secondary scanning direction, a second edge that is slanted from the first edge and crosses the first edge, and a solid part between the first edge and the second edge. The nozzle unit position detecting unit (a) determines a density distribution of the test pattern in the scanned image, (b) on the basis of the density distribution, determines an intersection point between the first edge and the second edge in each of the patch images respectively corresponding to the plural nozzle units, and (c) determines respective positions of the plural nozzle units on the basis of positions of the determined intersection points.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of a recording head 1 in the image forming apparatus 10 shown in FIG. 1;

FIG. 3 shows a block diagram that indicates an electronic configuration of the image forming apparatus 10 in the embodiment according to the present disclosure;

FIG. 4 shows a diagram that explains patch images 12A(m, n) and 12B(m, n);

FIG. 5 shows a diagram that indicates an example of a scanned image 80 of a print sheet that includes a test pattern 13 in FIG. 2;

FIG. 6 shows a diagram that explains patch images 81A(m, n) and 81B(m, n) in the scanned image shown in FIG. 5; and

FIG. 7 shows a diagram that explains a reference position in Embodiment 2.

### DETAILED DESCRIPTION

Hereinafter, embodiments according to an aspect of the present disclosure will be explained with reference to drawings.

### Embodiment 1.

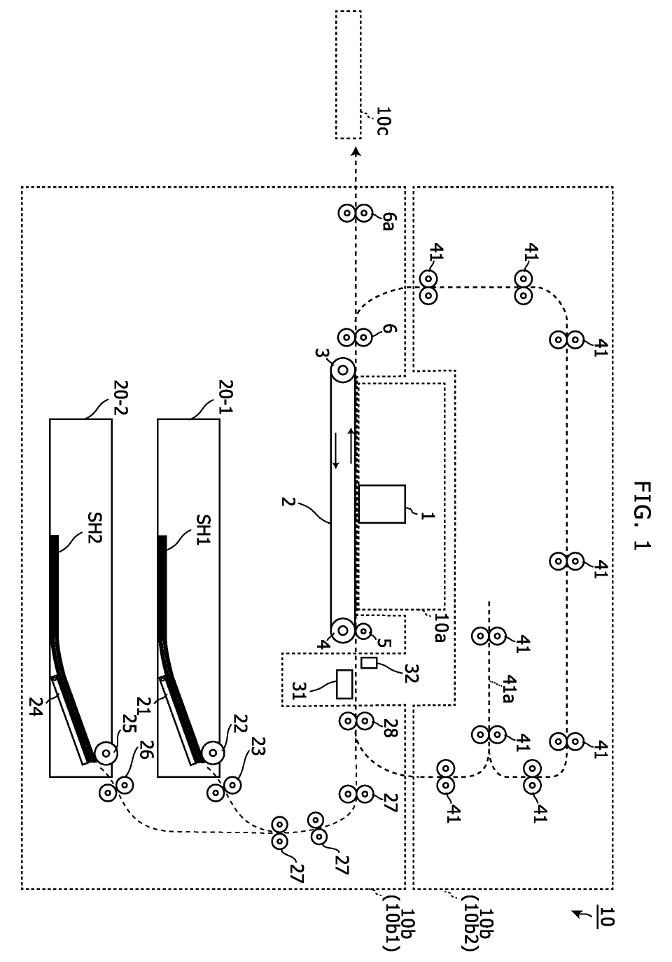

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes a fixed line-type head unit 1 that includes nozzle units for four ink colors: Cyan, Magenta, Yellow, and Black.

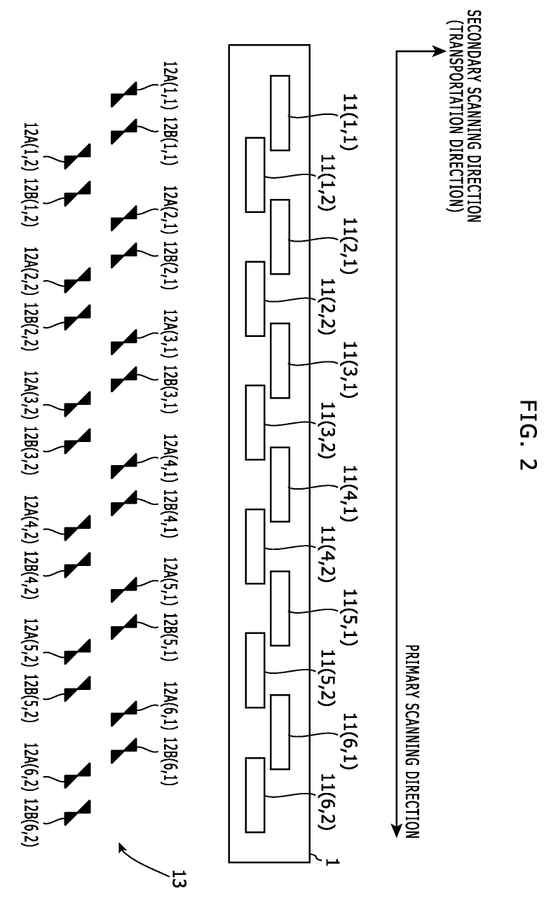

FIG. 2 shows a plane view of an example of a recording head 1 in the image forming apparatus 10 shown in FIG. 1. As shown in FIG. 2, for example, the recording head 1 includes plural nozzle units 11(m, n) (m = 1, ..., M, n = 1, 2). The plural nozzle units 11(m, n) are arranged along a primary scanning direction as at least two arrays (here, two arrays, n = 1, 2), and parts of depicting ranges of nozzle units 11(m, n) adjacent to each other in the primary scanning direction among the plural nozzle units 11(m, n) are overlapped to each other. The number of the nozzle units 11(m, n) is not limited.

In this embodiment, each nozzle unit 11(m, n) includes nozzle groups for four ink colors Cyan, Magenta, Yellow and Black, and nozzles for each ink color are arranged such that ejection positions of the nozzles in the primary scanning direction have a regular interval. It should be noted that instead of the recording head 1, independent recording heads for the four ink colors may be installed.

Each nozzle unit 11(m, n) can be mounted and demounted to the recording head 1. Therefore, positional deviation may occur on each nozzle unit 11(m, n). Each nozzle unit 11(m, n) includes plural nozzles arranged 2-dimensionally, plural pressure chambers that are connected to the plural nozzles respectively and to which ink is supplied, and plural piezoelectricity actuators that are installed in the pressure chambers, are driven by a driving signal corresponding to image data of an image to be printed and pushes ink from the pressure chambers to the nozzles and thereby cause the nozzles to eject ink; and ejects ink corresponding to the image to be printed from the nozzles.

Returning to FIG. 1, the sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the print sheet is transported by the transportation belt 2 to a printing position of the inkjet recording unit 1, and on the print sheet, images of respective colors are printed by the inkjet recording unit 1. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32. The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

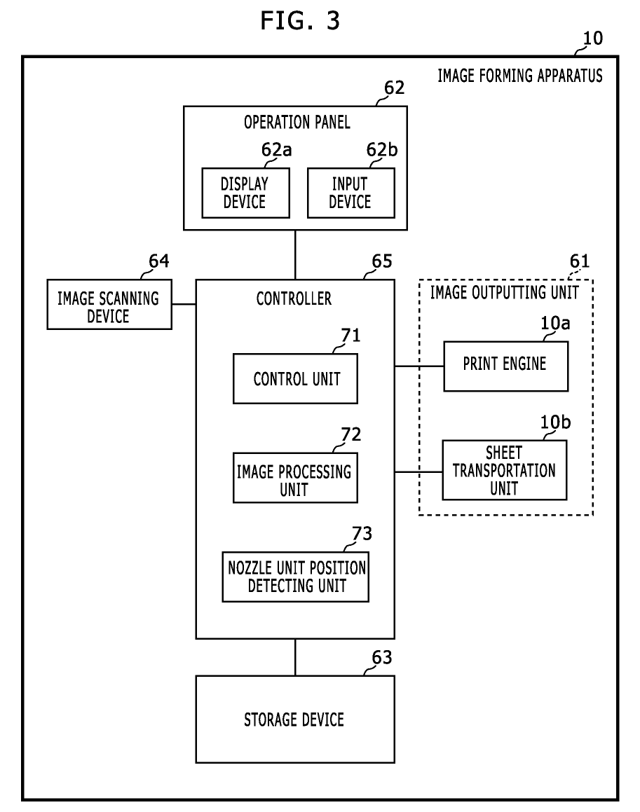

FIG. 3 shows a block diagram that indicates an electronic configuration of the image forming apparatus 10 in the embodiment according to the present disclosure. As shown in FIG. 3, the image forming apparatus 10 includes not only an image outputting unit 61 that includes the mechanical configuration shown in FIGS. 1 and 2 but an operation panel 62, a storage device 63, an image scanning device 64, and a controller 65.

The operation panel 62 is arranged on a housing surface of the image forming apparatus 10, and includes a display device 62a such as a liquid crystal display and an input device 62b such as a hard key and/or a touch panel, and displays sorts of messages for a user using the display device 62a and receives a user operation using the input device 62b.

The storage device 63 is a non-volatile storage device (flash memory, hard disk drive or the like) in which data, a program and the like have been stored that are required for control of the image forming apparatus 10.

The image scanning device 64 includes a platen glass and an auto document feeder, and optically scans a document image from a document put on the platen glass or a document fed by the auto document feeder, and generates image data of the document image.

The controller 65 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 63, the ROM or the like to the RAM and executes the program using the CPU and thereby acts as processing units (with the ASIC if required). Here, the controller 65 acts as a control unit 71, an image processing unit 72, and a nozzle unit position detecting unit 73.

The control unit 71 controls the image outputting unit 61 (the print engine 10a, the sheet transportation unit 10b and the like), and thereby performs a print job requested by a user. In this embodiment, the control unit 71 causes the image processing unit 72 to perform a predetermined image process, and controls the print engine 10a (the recording head 1) and causes the recording head 1 to eject ink and thereby forms a print image on a print sheet. Specifically, the control unit 71 supplies a driving signal to each of the piezoelectricity actuators in the nozzle units 11(m, n) and thereby causes to eject ink from the nozzles. The image processing unit 72 performs a predetermined image process such as RIP (Raster Image Processing), color conversion, halftoning and/or the like for image data of a printing image.

As mentioned, the control unit 71 causes the print engine 10a to print a user document image based on printing image data specified by a user.

Further, in this embodiment, the control unit 71 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process. Specifically, in the automatic centering function, the control unit 71 changes a depicting position of the image to be printed, in a primary scanning direction by a difference between a reference center position of the print engine 10a and the actual sheet center position. In this embodiment, because the nozzles of the recording head 1 do not move, a nozzle corresponding to each pixel in the image to be printed is changed correspondingly to the depicting position of the image to be printed.

As mentioned, the control unit 71 determines nozzles corresponding to the image to be printed (a nozzle corresponding to each pixel), correspondingly to a position of a print sheet, and causes the recording head 1 to eject ink from the determined nozzles.

Using the control unit 71, the nozzle unit position detecting unit 73 (a) prints a test pattern 13 on a print sheet using the recording head 1 and (b) detects positions of the nozzle units 11(m, n) on the basis of a scanned image of the test pattern.

As shown in FIG. 2, the test pattern 13 includes patch images 12A(m, n), 12B(m, n) respectively corresponding to the plural nozzle units 11(m, n). Here, correspondingly to one of the nozzle units 11(m, n), two patch images 12A(m, n), 12B(m, n) are set.

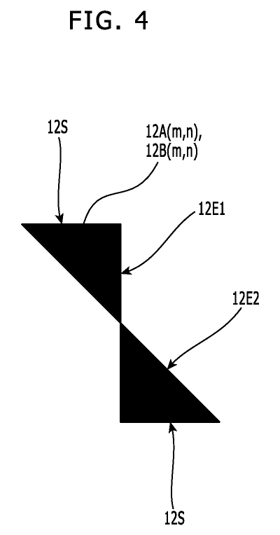

FIG. 4 shows a diagram that explains patch images 12A(m, n) and 12B(m, n). For example, as shown in FIG. 4, each patch image 12A(m, n), 12B(m, n) includes a first edge 12E1 of a straight-line shape along a secondary scanning direction, a second edge 12E2 of a straight-line shape that is slanted from the first edge 12E1 and crosses the first edge 12E1, and a solid part 12S between the first edge 12E1 and the second edge 12E2. Here, the solid part 12S has a substantial isosceles-right-triangle shape of a single density.

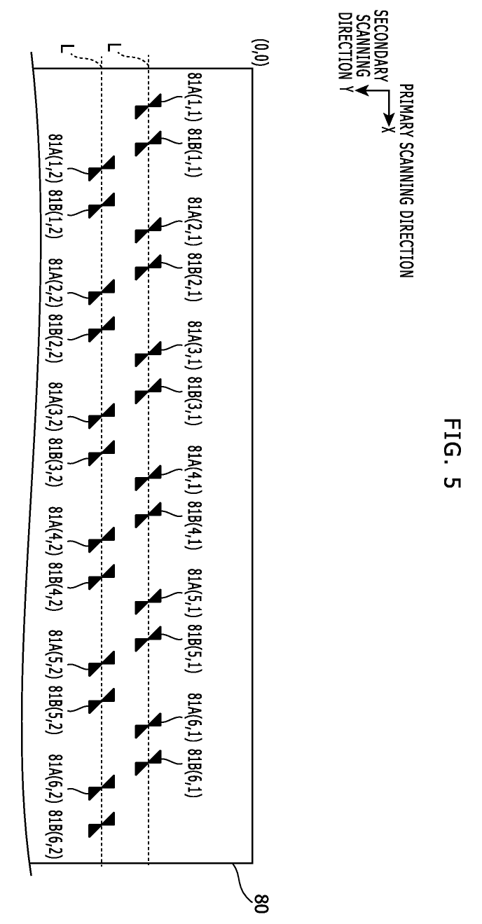

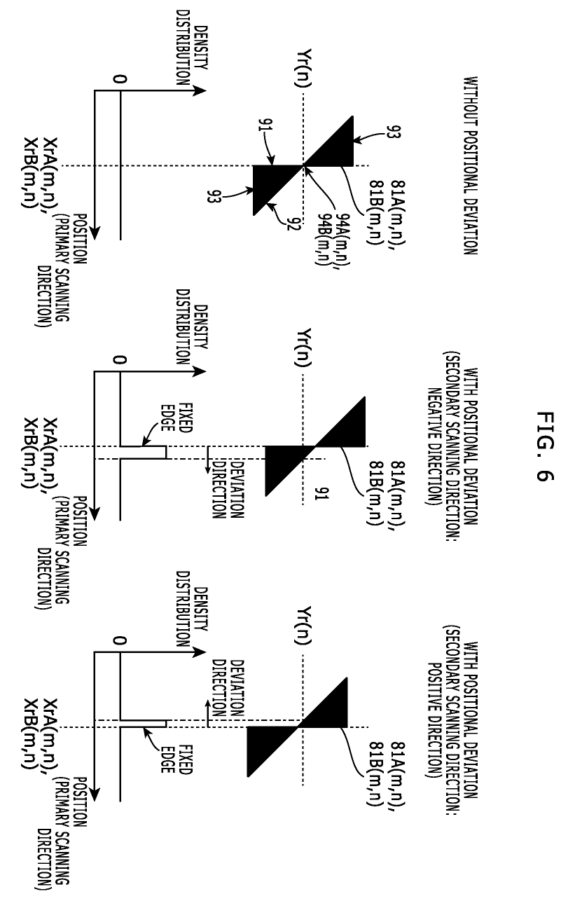

FIG. 5 shows a diagram that indicates an example of a scanned image 80 of a print sheet that includes a test pattern 13 in FIG. 2. FIG. 6 shows a diagram that explains patch images 81A(m, n) and 81B(m, n) in the scanned image shown in FIG. 5. For example, as shown in FIGS. 5 and 6, a patch image 81A(m, n), 81B(m, n) corresponding to the patch image 12A(m, n), 12B(m, n) includes a first edge 91 corresponding to the first edge 12E1, a second edge 92 corresponding to the second edge 12E2, and a solid part 93 corresponding to the solid part 12S.

The nozzle unit position detecting unit 73 (a) determines a density distribution of the test pattern 13 in the aforementioned scanned image 80 as shown in FIG. 5, for example, (b) on the basis of the density distribution, determines an intersection point 94A(m, n), 94B(m, n) between the first edge 91 and the second edge 92 in the patch images 81A(m, n), 81B(m, n) respectively corresponding to the plural nozzle units 11(m, n), and (c) determines respective positions of the plural nozzle units 11(m, n) on the basis of positions of the determined intersection points 94A(m, n), 94B(m, n).

Specifically, as shown in FIG. 6, for example, a primary-scanning-directional density distribution at a reference position Yr(n) in a secondary scanning direction. If there is no deviation in the secondary scanning direction, a density at each position in the density distribution is substantially zero, and if there is deviation in the secondary scanning direction, a section having a density appears in the density distribution. An amount of positional deviation in the secondary scanning direction is determined on the basis of a width of the section. The wider the section is, the larger amount of positional deviation in the secondary scanning direction is determined. Further, for example, primary-scanning-directional density distributions at plural secondary-scanning-directional positions including the reference position Yr(n) are determined, and a direction of the positional deviation (a positive direction or a negative direction in the secondary scanning direction) is determined correspondingly to a position of an edge of which a primary-scanning-directional position changes against an edge of which a primary-scanning-directional position does not change (called "fixed edge") when the secondary-scanning-directional positions are changed (i.e. correspondingly to a positive-directional position or a negative-directional position from the fixed edge), among both end edges of the aforementioned section having a density.

In the aforementioned manner, for each patch image 81A(m, n), 81B(m, n) (the intersection point 94A(m, n), 94B(m, n)), a position in the secondary scanning direction (i.e. a positional-deviation amount from the reference position Yr(n)) is determined. Further, a difference between a primary-scanning-directional reference position XrA(m, n), XrB(m, n) and a position of the fixed edge is determined as the primary-scanning-directional position (i.e. a positional-deviation amount from the reference position XrA(m, n), XrB(m, n)). XrA(m, n) is a reference position of the intersection point 94A(m, n), and XrB(m, n) is a reference position of the intersection point 94B(m, n).

In Embodiment 1, regarding each nozzle unit 11(m, n) other than a specific nozzle unit (here, the nozzle unit 11(1, 1)) among the plural nozzle units 11(m, n), the aforementioned reference position is a position apart by a predetermined relative distance from the determined position for the specific nozzle unit (from the intersection point 94A(1, 1) of the patch image 81A(1, 1)).

The predetermined relative distance for a nozzle unit 11(m, n) is a distance (a primary-scanning-directional distance and a secondary-scanning-directional distance) from the nozzle unit 11(1, 1) without the positional deviation to this nozzle unit 11(m, n), namely, a distance from the intersection point 94A(1, 1) to the intersection point 94A(m, n), and has been determined in advance.

Further, regarding each of the plural nozzle units, the nozzle unit position detecting unit 73 corrects an ink ejection position on the basis of a difference between the determined position of the aforementioned intersection point 94A(m, n), 94B(m, n) and a reference position (XrA(m, n), Yr(n)), (XrB(m, n), Yr(n)) (i.e. on the basis of the aforementioned positional deviation). The control unit 71 causes the recording head 1 to eject ink at the corrected ink ejection position when printing.

The following part explains a behavior of the image forming apparatus 10.

Using the control unit 71, the nozzle unit position detecting unit 73 causes the image outputting unit 61 to print the aforementioned test pattern 13 of each ink color on a print sheet. The test pattern 13 is printed without the correction of the aforementioned ink ejection position.

Subsequently, the nozzle unit position detecting unit 73 acquires a scanned image 80 of the test pattern using the line sensor 31 or the image scanning device 64, as mentioned.

Subsequently, the nozzle unit position detecting unit 73 determines a reference position corresponding to each nozzle unit 11(m, n) in the scanned image 80 of the test pattern.

In Embodiment 1, the nozzle unit position detecting unit 73 determines a position of the intersection point 94A(1, 1) of the patch image 81A(m, n) corresponding to the nozzle unit 11(m, n) in the scanned image 80, and derives the reference positions (XrA(m, n), Yr(n)), (XrB(m, n), Yr(n)) for remaining nozzle units 11(m, n) on the basis of the determined position, as mentioned.

Further, the nozzle unit position detecting unit 73 determines density distributions in the primary scanning direction at the reference position Yr(n) and positions previous and next to the reference position, and determines a relative position of each patch image 81A(m, n), 81B(m, n) from the reference position (XrA(m, n), Yr(n)), (XrB(m, n), Yr(n)) and thereby determines a position of the nozzle unit 11(m, n) (i.e. a position of a reference part (center or the like) of the nozzle unit 11(m, n)).

In the aforementioned manner, a relative position (i.e. deviation) of the nozzle unit 11(m, n) is determined.

Afterward, when receiving a print request, the control unit 71 causes the image processing unit 72 to perform an image process for an image specified by the print request, and thereby acquires image data of the image to be printed; and causes the image outputting unit 61 to transport a print sheet and print the image to be printed on the print sheet on the basis of the image data.

In this process, the control unit 71 determines a nozzle corresponding to each pixel in the image to be printed, in consideration with the aforementioned positional deviation, and causes to eject ink from a nozzle with an ink amount corresponding to a pixel value of the pixel corresponding to the nozzle, and thereby performs printing of the aforementioned image to be printed.

As mentioned, in the aforementioned embodiment, the nozzle unit position detecting unit 73 (a) prints a test pattern 13 on a print sheet using the recording head 1 and (b) detects positions of the nozzle units 11(m, n) on the basis of a scanned image of the test pattern. The test pattern 13 includes patch images 12A(m, n), 12B(m, n) respectively corresponding to the plural nozzle units 11(m, n). The patch image 12A(m, n), 12B(m, n) includes a first edge 12E1 of a straight-line shape along a secondary scanning direction, a second edge 12E2 of a straight-line shape that is slanted from the first edge 12E1 and crosses the first edge 12E1, and a solid part 12S between the first edge 12E1 and the second edge 12E2. Further, the nozzle unit position detecting unit 73 (a) determines a density distribution of the test pattern in the scanned image 80, (b) on the basis of the density distribution, determines an intersection point 94A(m, n), 94B(m, n) between the first edge 91 and the second edge 92 in the patch images 81A(m, n), 81B(m, n) respectively corresponding to the plural nozzle units 11(m, n), and (c) determines respective positions of the plural nozzle units 11(m, n) on the basis of positions of the determined intersection points 94A(m, n), 94B(m, n).

Consequently, even if a blank line due to ink ejection malfunction appears in the patch image 12A(m, n), 12B(m, n), a position of the intersection point 94A(m, n), 94B(m, n) of the patch image 81A(m, n), 81B(m, n) in the scanned image 80 is determined relatively correctly, and therefore, a position of the nozzle unit 11(m, n) is correctly detected.

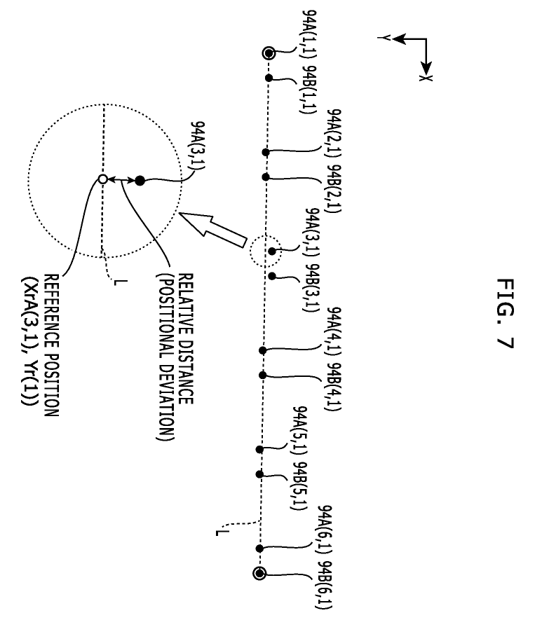

FIG. 7 shows a diagram that explains a reference position in Embodiment 2. In Embodiment 2, regarding each nozzle unit other than two specific nozzle units among the plural nozzle units 11(m, n), the aforementioned reference position is a position on a straight line that passes at the determined positions of the intersection positions of the two specific nozzle units.

Specifically, firstly, in the scanned image 80, positions of the intersection points 94A(1, 1), 94B(6, 1) for the nozzle units 11(1, 1), 11(6, 1) at both ends are determined; a straight line L that passes at the positions is determined; and determined as the aforementioned reference position is a position apart from the intersection points 94A(1, 1), 94B(6, 1) among the intersection points 94A(m, 1), 94B(m, 1) by a predetermined distance on the straight line L. This predetermined distance is a distance to each intersection point 94A(m, 1), 94B(m, 1) without the positional deviation, and has been determined in advance.

Here, the plural nozzle units 11(m, 1) (m = 1, ..., 6) are explained, and the plural nozzle units 11(m, 2) are as the same.

Other parts of the configuration and behaviors of the image forming apparatus in Embodiment 2 are identical or similar to those in Embodiment 1, and therefore not explained here.

As mentioned, in Embodiment 2, both end positions of an array of the nozzle units 11(m, 1), 11(m, 2) are 2-dimentionally determined, and the reference position is set on the straight line L that passes at the both end positions, and therefore, the positional deviation is properly detected even if a skew occurs when printing and/or scanning the test pattern.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in Embodiment 1 or 2, the nozzle unit position detecting unit 73 may determine a gradient of each nozzle unit 11(m, n) on the basis of positions of the intersection positions 94A(m, n) , 94B(m, n) of the patch images 81A(m, n), 81B(m, n) corresponding to each nozzle unit 11(m, n), and may correct an ink ejection position of each nozzle in the nozzle unit 11(m, n) in consideration with the determined gradient.

What is claimed is:

1. An image forming apparatus, comprising:
a recording head that comprises plural nozzle units in which nozzles are arranged, configured to eject ink using the nozzles units; a control unit configured to determine nozzles corresponding to an image to be printed and eject ink using the nozzle units; and a nozzle unit position detecting unit configured to (a) print a test pattern on a print sheet using the recording head and (b) detect positions of the nozzle units on the basis of a scanned image of the test pattern; wherein the test pattern comprises patch images respectively corresponding to the plural nozzle units; each of the patch image comprises a first edge along a secondary scanning direction, a second edge that is slanted from the first edge and crosses the first edge, and a solid part between the first edge and the second edge; and
the nozzle unit position detecting unit (a) determines a density distribution of the test pattern in the scanned image, (b) on the basis of the density distribution, determines an intersection point between the first edge and the second edge in each of the patch images respectively corresponding to the plural nozzle units, and (c) determines respective positions of the plural nozzle units on the basis of positions of the determined intersection points.

2. The image forming apparatus according to claim 1, wherein the nozzle unit position detecting unit corrects an ink ejection position on the basis of a difference between the determined position of the intersection point and a reference position, regarding each of the plural nozzle units.

3. The image forming apparatus according to claim 2, wherein regarding each nozzle unit other than a specific nozzle unit among the plural nozzle units, the reference position is a position apart by a predetermined relative distance from the determined position of the intersection position of the specific nozzle unit.

4. The image forming apparatus according to claim 2, wherein regarding each nozzle unit other than two specific nozzle units among the plural nozzle units, the reference position is a position on a straight line that passes at the determined positions of the intersection positions of the two specific nozzle units.
